(19) United States
(12) Patent Application Publication
(10) Pub. No.: US 2002/0052903 A1
(43) Pub. Date: May 2, 2002

(54) TEXT INPUT METHOD

(76) Inventor: MITSUHIRO AIDA, NARA (JP)

Correspondence Address: MITSUHIRO AIDA, 3-8-25 SAIKUJO CHO, NARA CITY, 630-8453, JP

(21) Appl. No.: 08/218,813

(22) Filed: Mar. 28, 1994

(30) Foreign Application Priority Data
May 31, 1993 (JP) 5-167266
Aug. 31, 1993 (JP) 93-102

(51) Int. Cl. G06F 17/60

(52) U.S. Cl. 707/541

(57) ABSTRACT

A text to input character by character is looked up in a dictionary to determine a unique line of text for the unique word with the same leading part as the input text. If successful, the remainder of the word is supplemented from the dictionary.

### BACKGROUND OF THE INVENTION

1. Field of the Invention

This invention relates to a text input method for an electronic data and word processing systems, and personal information systems including a handwritten character recognition function.

2. History of the Prior Art

The conventional system to lower the burden of text input has a way of using an abbreviation of the word being frequently used as well as a shorhand that assign a single character to a longer line of text or commands.

However, it is inconvenient in that such way should get a person remember each of the abbreviation and shorthand and the expectation to increase the input performance depends on each person's mnemonics.

Present invention was made to improve the above-mentioned defect of conventional systems, providing an efficient way to use it without particular skill.

### SUMMARY OF INVENTION

Present invention has a dictionary to find a unique word in comparison with the word data input, character by character, and automatically supplements the remaining part of the word data input with those from the dictionary if the dictionary has the unique one with the same leading part as the word data in the input buffer.

### BRIEF DESCRIPTION OF THE DRAWING

FIG. 1 is a flowchart for the entire process of the present invention method.

FIG. 2 and FIG. 3 are examples of the dictionary to use by the invention method.

### DETAILED DESCRIPTION

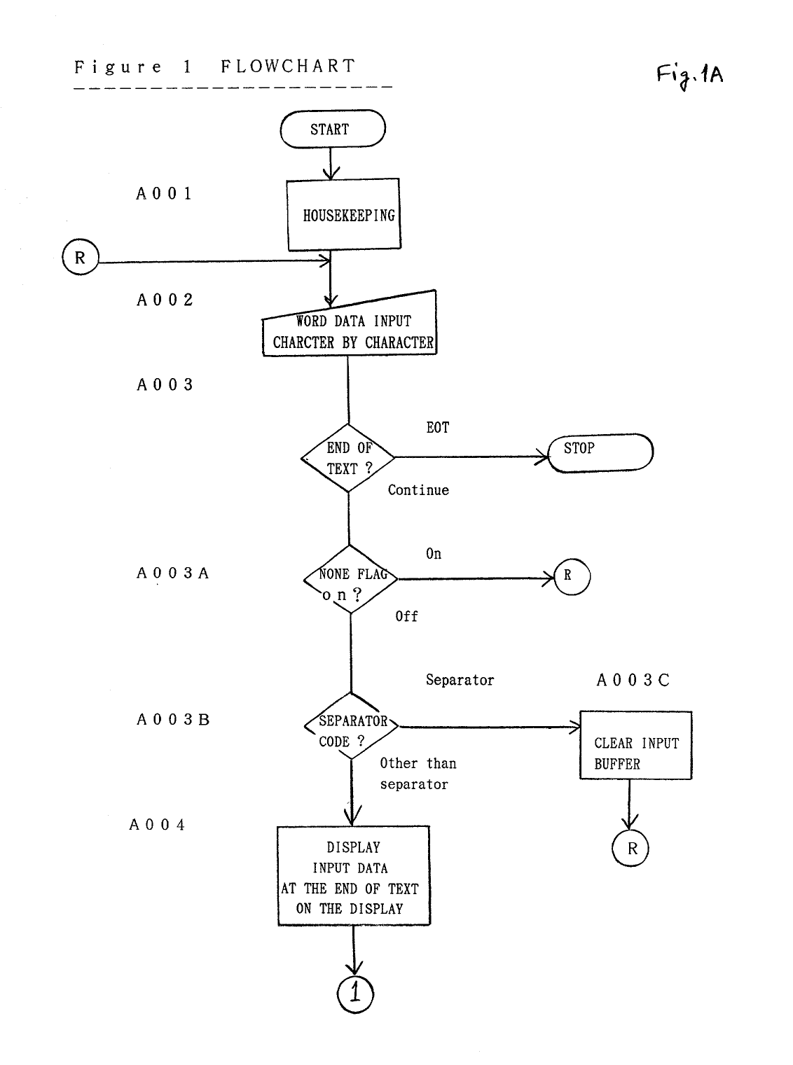

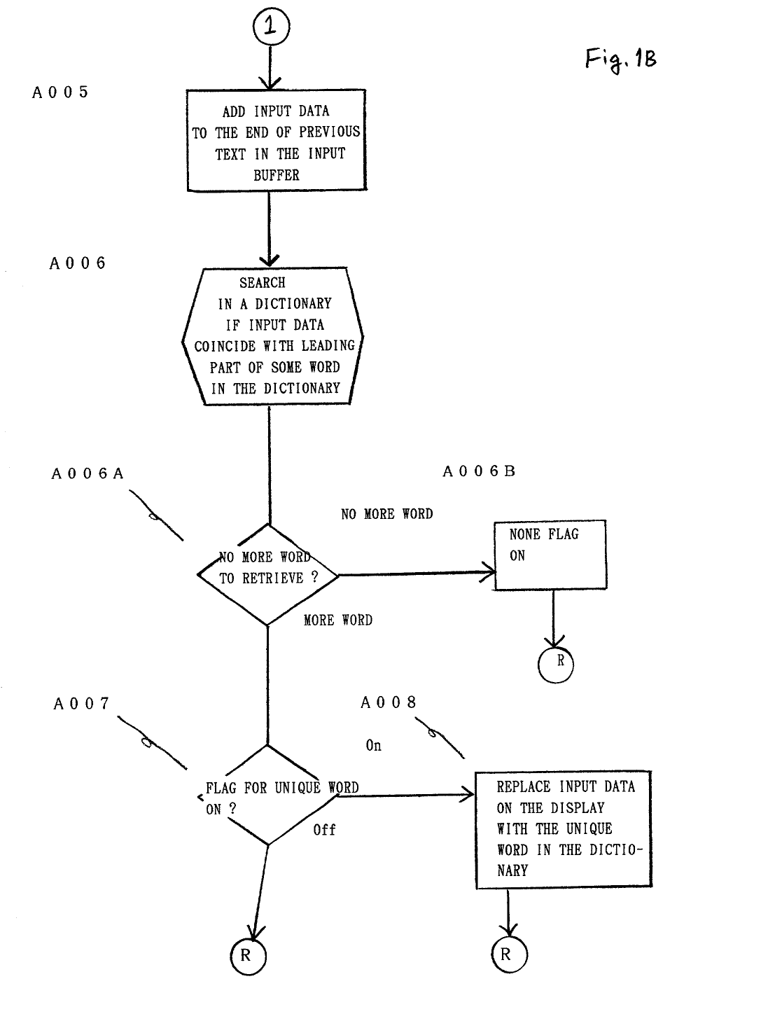

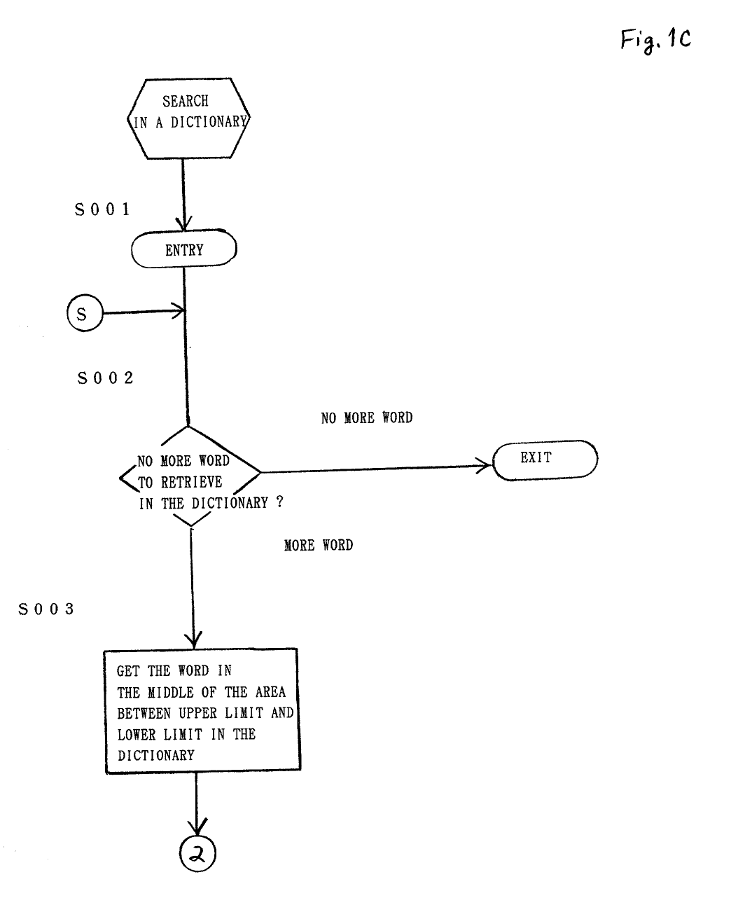

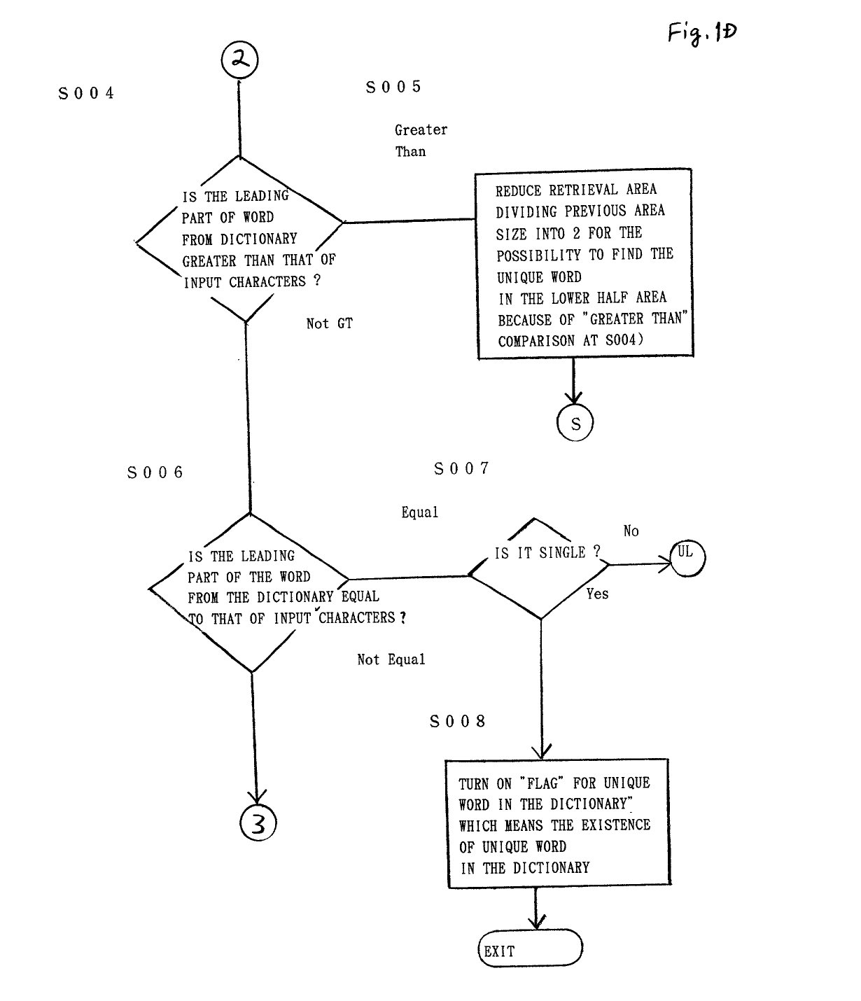

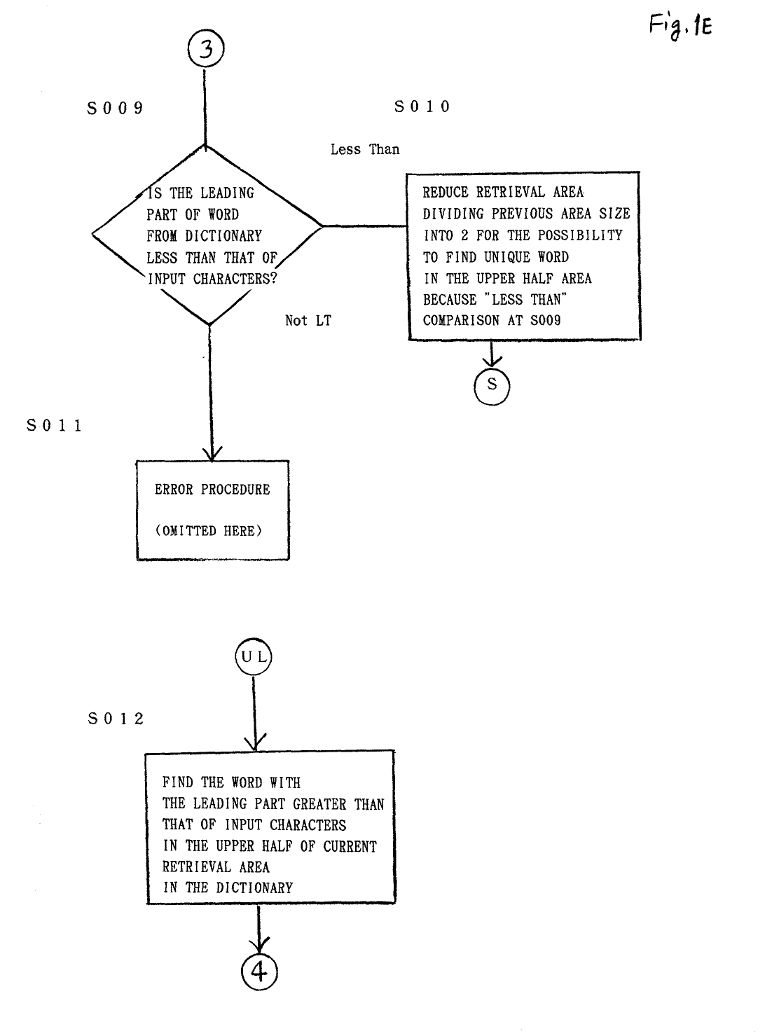

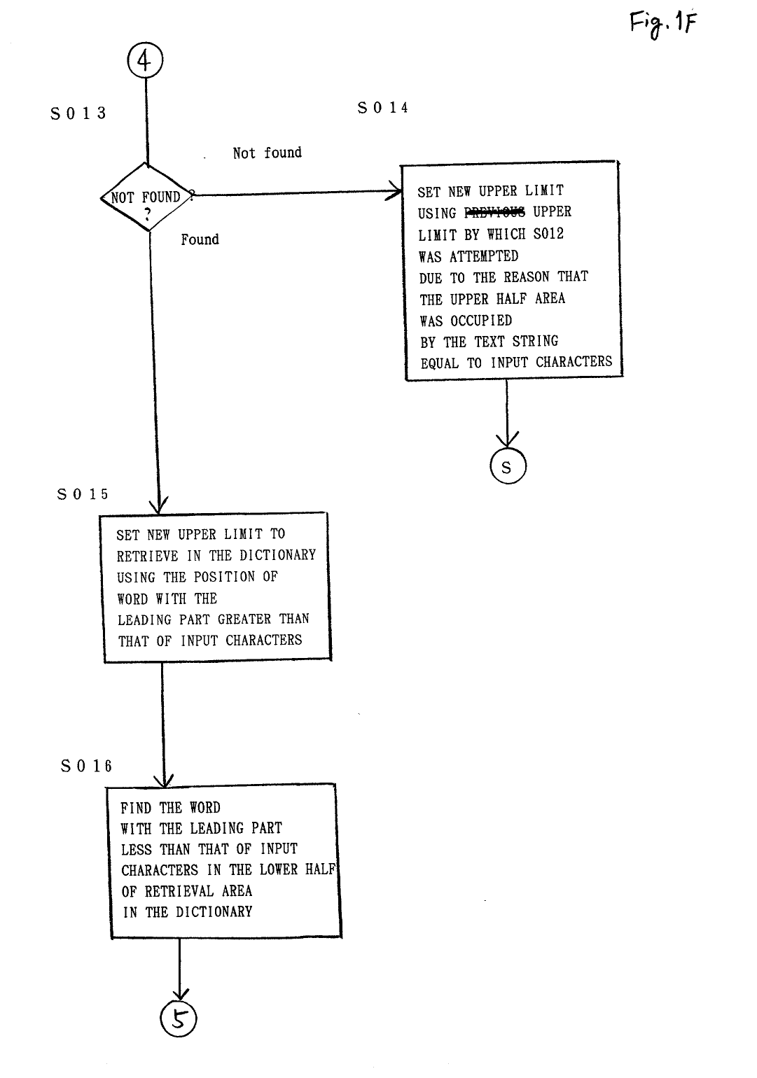

By the way of example, the method of the present invention is described in a flowchart in FIG. 1.

In FIG. 1, A001 is the first step to clear the contents of the program counter, flag, and the working area.

A002 accepts a word data from input means, character by character.

A003 checks if the input is the end of text code, and goes to the stop point of this process if it is the end. Otherwise, the step proceeds to the next A003A.

A003A tests if the none flag is ON which means that there is no word in the dictionary with the same leading part as the word data input. And if ON, the step goes back to A002. If OFF, the step proceeds to A003B.

A003B tests if the input is a word separator code. If it is the separator, A003C takes place to clear the contents of input buffer because of the termination of the word input and then the step goes back to A002 for the next word input.

A004 arises if the input is not separator code at A003B and the input data is displayed at the end of text on the display.

A005 is the step to add the input data to the end of previous text in the input buffer memory.

A006 performs a dictionary search to know if the word data input is the same as the leading part of some line of text to represents unique word in the dictionary.

A006A tests the result of the dictionary search at A006.

In case of negative result, A006B takes place to turn on the none flag and goes back to A002. Affirmative result brings the process to the next A007.

A007 confirms if A006 found a single one by testing the flag for the unique word. If not, the step goes back to A002.

Otherwise, A008 takes place in which the input text on the display is replaced with those of the unique word from the dictionary and then jumps to the step of A002.

S001 is an entry of the subprogram to search the unique line of text to represent the unique word in the dictionary. S002 is to test if there is no more word to retrieve in the dictionary. If not so, the process goes to the next S003. Otherwise, it goes to the exit of this subprogram.

S003 gets the word located in the middle of the area between upper limit and lower limit in the dictionary.

Next S004 checks if the leading part of the word from dictionary is greater than that of word data input.

If the greater flag is ON at S004, S005 gets up to divide the retrieval area size into 2 to use the lower half are a for the next retrieval, as there is a possibility to find the unique word in the lower half area, because the dictionary word found at S003 was greater than the word data input. Then, the step goes back to S002. If the greater than flag is OFF at S004, the step proceeds to S006.

At S006, it is tested if the leading part of the word data from the dictionary is equal to that of the word data input.

If equal, S007 is performed to investigate if it is single.

In case of a single word, next step S008 turns on the flag for the unique word in the dictionary and goes to exit.

If there are plural words, the step goes to S012.

If not equal at S006, the step proceeds to S009 in which the testing is made if the leading part of the word data from the dictionary is less than that of the word data input.

If the less than flag is ON after testing at S009, S010 divides the retrieval area size into 2 to use the upper half area for the next retrieval, as there is a possibility to find the unique word in the upper half area because the dictionary word found at S003 was less than that of word data input.

If the less than flag is OFF at S009, there is something wrong with the procedure in the program and goes to the error procedure of S011 which is not described here.

Jumping here from S007, S012 tries to find the word with the leading part greater than that of the word data input in the upper half of the retrieval area in the dictionary.

At the next S013, the step goes to S014 if no word was found, and goes to S015 if found.

S014 sets new upper limit to retrieve in the dictionary using the position of the upper limit by which S012 was attempted because the upper half area in this case is occupied by the word data with the leading part equal to that of the word data input. Then, the step goes back to A002.

S015 sets new upper limit to retrieve in the dictionary using the position of the word found at the step of S012.

S016 tries to find the word with the leading part less than that of the word data input in the lower half area of the dictionary.

S017 tests if the word was found.

S018 takes place if not found at S017 and sets new lower limit using the position of the lower limit by which S016 was attempted because the lower area is occupied by the word data with the leading part equal to that of the word data input. Then, the step goes back to S002.

S019 arises if found at S017 and sets new lower limit to retrieve using the position of the word with the leading part less than that of the word data input and jumps back to S002.

As a subset of a dictionary search for the word data input consisting of a first character and some other characters, T001 which is equivalent to the aforementioned S001, is an entry of this subprogram.

T002 which is equivalent to the aforementioned S002 checks if there is still more word to retrieve in the dictionary. If there is no more word, the step goes to the exit. The process advances to the next T002A, if there are some more words to retrieve.

T002A branches to the aforementioned S003 if the input is the first one of the word data input, and to the next T002B if it was not first.

T002B is to check if all words between upper and lower limit in the dictionary have the same leading part as that of the word data input.

T002C selects the words with the leading part which is not same as that of the word data input.

T002D shifts one character to the left for every words selected at T002C and extract those if terminated after making a character shift.

T002E sets new upper and lower limit to retrieve in the dictionary after extracting words terminated at S003. Then, the step goes to the aforementioned S003.

What is claimed is:

1. A text input method comprising;
input means for inputting a plurality of word data;
dictionary means for storing a plurality of a line of text to represent a unique word in the said dictionary, original word data, and relevant word data;
means for determining the said unique line of text to represent the said unique word with the same leading part as the said data word from said input means, in the dictionary;
means for selecting a desired word among the said relevant words in case of that the said unique word has the said relevant words in the dictionary;
output means for outputting the said unique word represented by the said line of text which was determined by the said means for determining, and outputting the said unique work selected by the said means for selecting;
means for controlling all the said means.

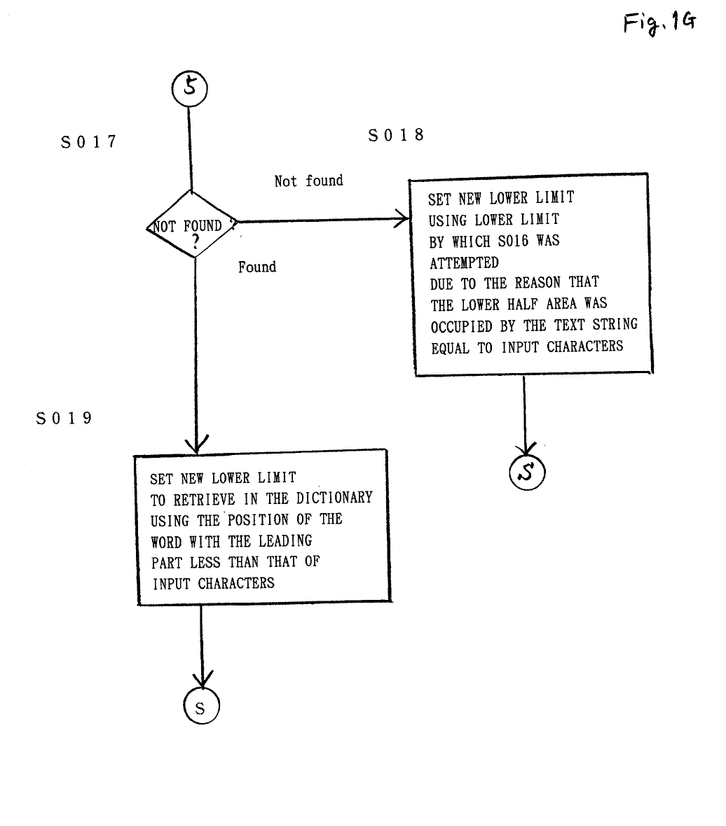

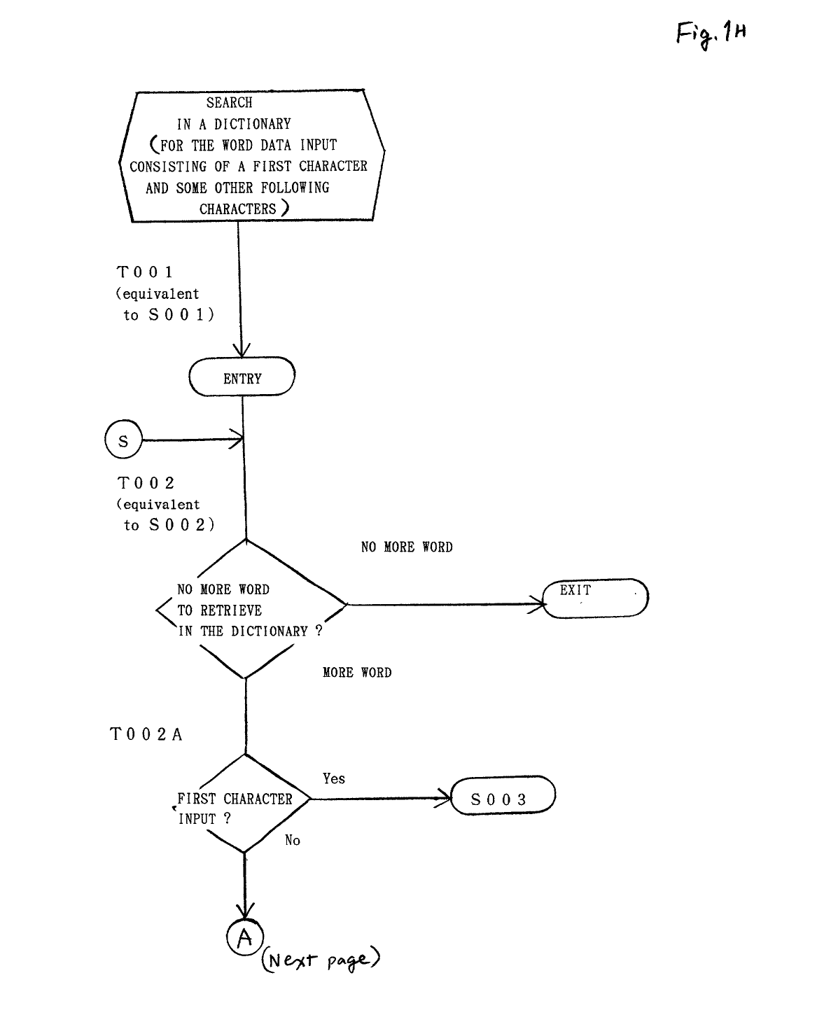

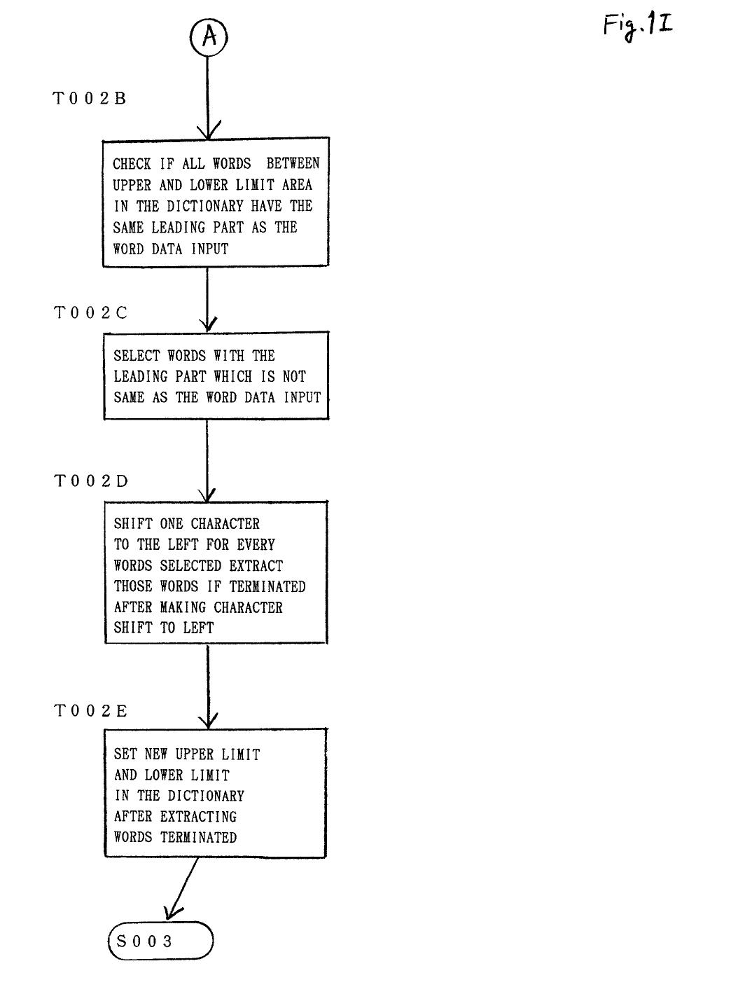

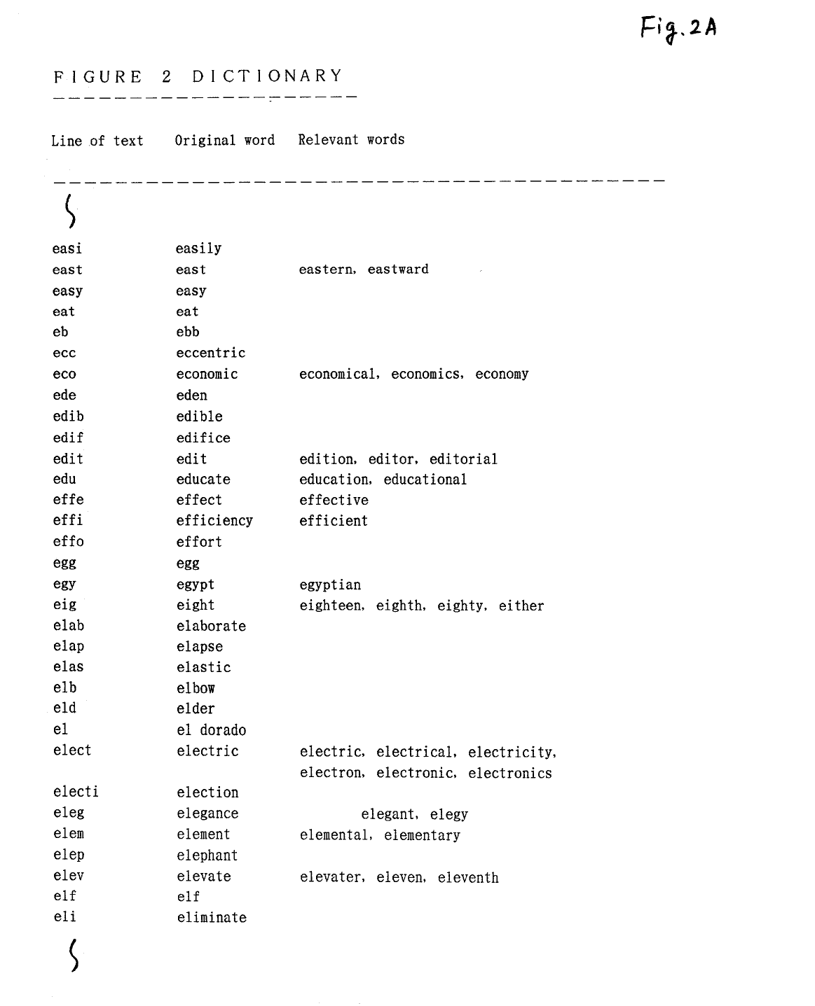

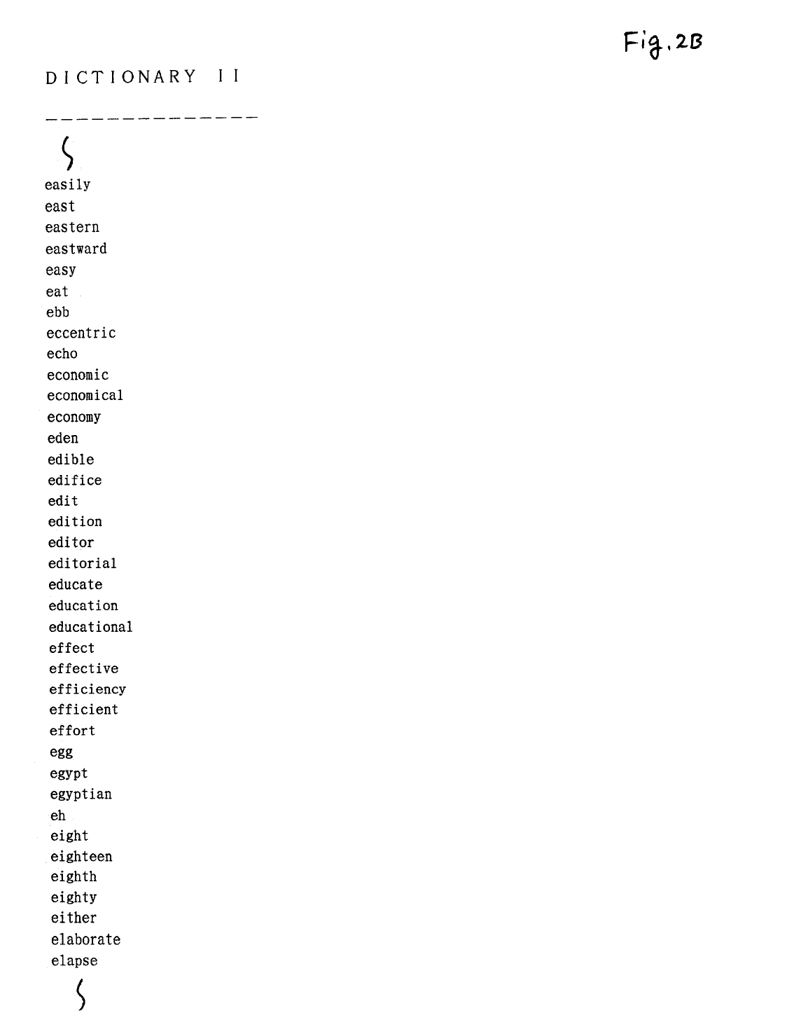

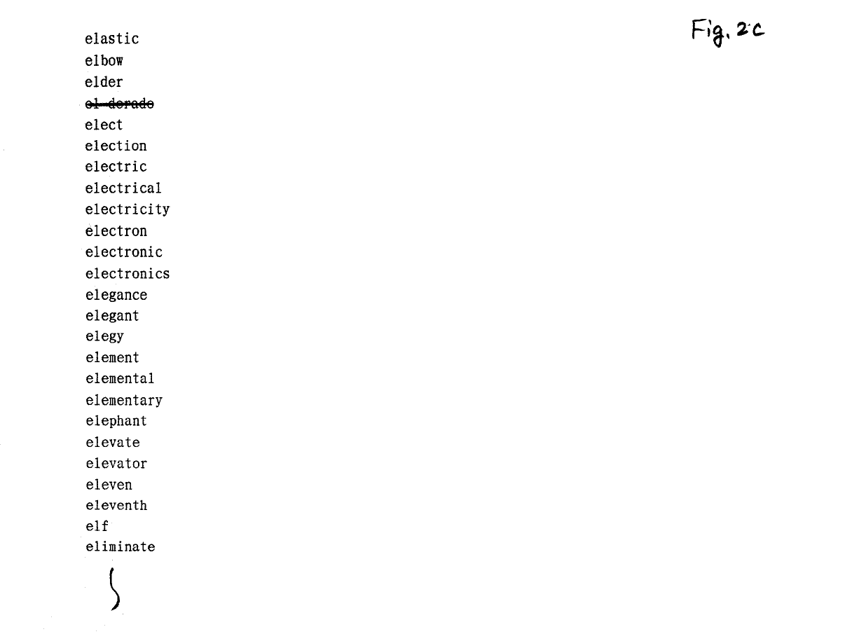

2. The method of claim 1, wherein the said dictionary means comprises a plurality of an ordinary word data in the dictionary in FIG. 2.

3. The method of claim 2, wherein the means of determining comprises the means to determine the said unique line of text to represent the said unique word with the same leading part as the said word data from said input means, in the said dictionary;

4. The method of claim 2, wherein the said input means comprises inputting a plurality of a first character followed by other characters of the said word data to input from said input means.

5. The method of claim 4, wherein the said means for determining comprises the means to determine the said unique line of text to represent the said unique word containing a first character followed by their characters of the said word data to put from said input means, in the dictionary.

6. The method of claim 1, wherein the said input means comprises inputting a plurality of a first character followed by other characters of the said word data to input from said input means.

7. The method of claim 6, wherein the said means for determining comprises the means to determine the said unique lin of text to represent the said unique word containing a first character followed by other characters in the said word data to input from said input means, in the dictionary.
